(19) United States
(12) Patent Application Publication
(10) Pub. No.: US 2023/0102943 A1
(43) Pub. Date: Mar. 30, 2023

(54) LAUNDRY TREATING APPARATUS

(71) Applicants: LG Electronics Inc., Seoul (KR); Seoul National University R&DB Foundation, Seoul (KR)

(72) Inventors: Taewoong KONG, Seoul (KR); Chaseung JUN, Seoul (KR); Sangwook HONG, Seoul (KR); Seungki SUL, Seoul (KR); Joohyun LEE, Gyeonggi-do (KR); Hwigon KIM, Gyeongsangnam-do (KR)

(21) Appl. No.: 17/802,649

(22) PCT Filed: Feb. 26, 2021
(86) PCT No.: PCT/KR2021/002515

§ 371 Date: Aug. 26, 2022

(30) Foreign Application Priority Data
Feb. 28, 2020 (KR) 10-2020-0025604
Feb. 26, 2021 (KR) 10-2021-0026714

(51) Int. Cl. D06F 34/10; D06F 34/26; D06F 39/04; D06F 58/26; D06F 58/40; H05B 6/10

(52) U.S. Cl. CPC D06F 34/10; D06F 34/26; D06F 39/04; D06F 58/26; D06F 58/40; H05B 6/10

(57) ABSTRACT

A laundry treating apparatus includes a tub, a drum rotatably provided in the tub, an induction heater which is fixed to the tub, is spaced apart from the drum, and heats the drum, a first circuit including a first coil installed in the tub, a power supply unit which applies AC power to the first coil, and a second circuit installed in the drum and including a second coil disposed in a position overlapping with the first coil in a length direction of a rotational central shaft of the drum and a thermistor having a resistance that varies based on a temperature.

### TECHNICAL FIELD

The present disclosure relates to a laundry treating apparatus.

### BACKGROUND ART

In general, a laundry treating apparatus may include a washing machine, a dryer, a device for refreshing clothes, and the like. The washing machine may be a washing machine having a drying function.

In a washing machine, a drum accommodating laundry is rotatably provided in a tub that provides a space for storing water. Through holes are formed in such a drum, so that water in the tub flows into the drum. In this state, when the drum is rotated, the laundry in the drum flows and contamination of the laundry is removed.

Such a washing machine is also provided with a heater for heating the water in the tub. The heater is operated in a state of being submerged in water in the tub, so it is common to directly heat the water. However, since this type of heater must always be operated in a state of being submerged in water at all times for safety reasons, it can be used for heating the water in the tub, but it is not suitable for heating the air in the drum in a state where There is no water in the tub, or for heating wet laundry before spin-drying.

Recently, a washing machine in which a drum is heated by an induction heating system has been used. Such a washing machine may be configured to have a heat sensor disposed between the drum and a tank (or tub) to detect the temperature of water or air in the tank.

In the above mentioned scheme, the temperature of the drum is inevitably estimated based on the temperature of water or air. Meanwhile, the temperature of the drum is sensitively fluctuated according to the output of an induction heating system, but the temperature of water or air is slowly fluctuated. Therefore, the value detected by a heat sensor may not accurately reflect the temperature fluctuation of the drum

Meanwhile, US Patent Application Publication No. US 2018/0148886 discloses a method of estimating a temperature by using a characteristic change of drum according to a temperature, in particular, by using an inductance change.

FIG. 1 shows a resonant circuit for using such a method. Referring to FIG. 1, the driving of a power device Q1 is turned off near a zero crossing of system voltage by using a resonance circuit 2, and at this time, resonance frequency (fres) can be measured by using an autonomous resonant voltage.

An inductance Leq can be derived by using the measured. resonant frequency (fres) and using a relational expression

$$( {f}_{res} = \frac{1}{2 π \sqrt{{L}_{eq} {C}_{eq}}} )$$

for resonant frequency, inductance, and capacitance.

Here, as the temperature increases, the relative magnetic permeability increases and the inductance (Leg) also increases. Accordingly, the temperature of a drum I (load) can be estimated through the change in inductance (Leq) according to the temperature change.

FIG. 2 shows a voltage waveform when measuring a resonance frequency, and FIG. 3 shows an enlarged view of a portion A of FIG. 2.

Referring to FIG. 2, it can be seen that the resonance frequency (fres) changes by about 0.015% when the load temperature changes by 1° C. That is, it can be seen that the fluctuation of the resonance frequency (fres) according to the temperature change is too small to estimate the temperature by using the resonance frequency.

That is, referring to FIG. 3, it can be seen that a portion of waveform W after a circuit is turned off is too small to measure the fluctuation

In addition, the change in inductance (Leq) fluctuates by 0.03%/° C. That is, it can fluctuate by 0.03% depending on the temperature. In addition, the capacitance (Ceq) in the resonant frequency (fres) calculation formula should be less than or equal to 0.003% depending on a dispersion of components and a fluctuation dispersion according to a temperature.

FIG. 4 is a graph illustrating a relationship between a temperature and a resonance frequency when estimating a temperature by using a resonance frequency.

Due to the circumstances described above, when a temperature is estimated by using a resonant frequency, an error of the estimated temperature may occur by about ±10° C. or more. However, in order to be applied to general washing machine products, accuracy within ±5° is required.

In addition, there is a problem in that a power of circuit must be turned off for a certain time in order to measure the resonance frequency (fres).

Therefore, an improvement or new method for accurately estimating the temperature of drum by solving these problems is required.

### DISCLOSURE

### Technical Problem

An object of the present disclosure is to solve the above and other problems.

Another object of the present disclosure is to provide a laundry treating apparatus, such as a dryer which can accurately estimate a temperature of a drum, a washing machine, a washing machine-and-dryer, and an apparatus for refreshing clothes.

Another object is to provide a laundry treating apparatus capable of heating a drum by an induction heater and accurately estimating the temperature of the drum

Another object of the present disclosure is to provide a laundry treating apparatus capable of accurately estimating the temperature of the drum by minimizing the influence of a magnetic field generated by the induction heater.

Another object of the present disclosure is to provide a laundry treating apparatus capable of accurately estimating the temperature of the drum regardless of a distance between a load (drum) and a tub.

Another object of the present disclosure is to provide a laundry treating apparatus capable of estimating the temperature of a rotating load (drum).

Another object of the present disclosure is to provide a laundry treating apparatus capable of continuously estimating a temperature without turning off a power device to estimate a temperature.

Another object of the present disclosure is to Provide a laundry treating apparatus that minimizes vibration due to unbalance, even when a drum having a device for estimating a temperature rotates at a high speed.

### Technical Solution

In order to achieve the above object, there provided a laundry treating apparatus according to an aspect of the present disclosure, including: a first circuit including a first coil and a second circuit including a second coil and a thermistor.

The resistance of the thermistor changes according to temperature, and the current value of the second coil changes according to the change is resistance of the thermistor. The resistance of the thermistor may change according to the temperature of a drum.

The thermistor may include an NTC thermistor whose resistance decreases when the temperature increases. The resistance of the NTC thermistor may decrease when the ambient temperature increases. The resistance of the NTC thermistor may decrease when the temperature of the drum increases.

The thermistor may include a PTC thermistor whose resistance increases when the temperature increases. The resistance of the PTC thermistor may increase as the ambient temperature increases. The resistance of the PTC thermistor may increase when the temperature of the drum increases.

The second circuit may be provided to be movable with respect to the first circuit. The second circuit may be provided to be movable with respect to the first coil.

The laundry treating apparatus includes a drum The drum may be rotatably provided.

The laundry treating apparatus may further include a tub accommodating the drum.

The drum may be rotatably provided in the tub.

The laundry treating apparatus may include a cabinet. The cabinet may form an outer shape of the laundry treating apparatus. The cabinet may accommodate the tub.

The first coil may be installed in the tub. The first circuit may be installed in the tub.

The first coil may be installed inside the cabinet. The first circuit may be installed in the cabinet.

The second circuit is disposed in the drum.

The second coil may be disposed at a position overlapping the first coil in the length direction of the rotation central shaft of the drum.

The second coil may be installed in a position passing the shortest distance from the first coil according to the rotation of the drum The second coil may be installed in a position where a straight line which passes the first coil and is perpendicular to the rotation center line of the drum meets the drum

The second circuit may be installed on the outer surface of the drum.

The laundry treating apparatus may include a lifter provided on an inner surface of the drum

The second circuit may be installed at a position corresponding to the lifter.

The second circuit may be installed at a position corresponding to the lifter on the outer surface of the drum

The second circuit may be installed on an outer surface of a portion of the drum where the lifter is disposed.

The second circuit may be installed on the inner surface of the drum in a portion of the drum where the lifter is disposed.

The drum may include a body having an extended cylindrical shape and a through hole formed in the body.

The laundry treating apparatus may include a non-magnetic balance maintaining unit. The balance maintaining unit may be provided in the drum The balance maintaining unit may be provided in the lifter. The balance maintaining unit may be provided in the lifter.

The second circuit and the balance maintaining unit may be arranged at regular intervals along a circumferential direction of the drum.

The balance maintaining unit may include one or more balance maintaining units. The second circuit and the one or more balance maintaining units may be arranged at regular intervals.

The lifter may include a plurality of lifters arranged at regular intervals along the circumferential direction of the drum.

The lifter may include a plurality of lifters. The plurality of lifters may be arranged at regular intervals along the circumferential direction of the drum.

The second circuit may be installed at a position corresponding to any one of the plurality of lifters.

The second circuit may be installed on an outer surface of a portion of the drum in which the any one lifter is disposed.

The balance maintaining unit may be provided at a position corresponding to remaining lifters among the plurality of lifters. The balance maintaining unit may be provided inside the remaining lifters.

The laundry treating apparatus includes an induction heater that heats the drum The induction heater may generate a magnetic field. The induction heater heats the drum by using a magnetic field.

The induction heater may be spaced apart from the drum The induction heater may be installed in the tub. The induction heater may be fixed to the tub.

The induction heater may be disposed inside the case or on an inner wall. In a laundry treating apparatus such as a dryer having no tub, it may be disposed inside a case or on an inner wall.

The first coil may be installed in an opposite side of the induction heater. The first coil may be installed in the opposite side of the induction heater with respect to the center of the tub. The first coil may be installed in the opposite side of the induction heater with respect to the center of the drum

The first coil may be installed within a range of ±60 degrees from an opposite point of the induction heater with respect to the center of the tub.

The induction heater may be disposed at a position spaced apart from the drum at an upper side, a lower side, or a right side of the drum inside the case, in a laundry treating apparatus having no tub such as a dryer. In this case, the first circuit including the first coil may be positioned opposite to the induction heater. Alternatively, it may be fixed to be spaced apart from the drum at a position spaced apart by a certain distance with respect to the drum rotation direction.

A size of the first coil may be greater than a size of the second coil. The first coil may occupy a larger area than the area occupied by the second coil along the circumferential direction of the drum.

The laundry treating apparatus may include a power supply unit for applying power to the first coil.

The power supply unit may apply AC power to the first coil. The power supply unit may apply a resonant frequency.

The first circuit may include capacitor. The capacitor may be connected in parallel with the first coil.

The laundry treating apparatus may include a controller.

The controller may be connected to the first circuit. The controller may estimate the temperature of the drum.

The controller may estimate the temperature of the drum based on a resistance value of the thermistor.

The laundry treating apparatus may include a current detection unit. The current detection unit may be connected in series with the first coil. The current detection unit may he connected in series with the power supply unit.

The laundry treating apparatus may include a voltage detection unit. The voltage detection unit may be connected in parallel with the first coil. The voltage detection unit may be connected in parallel with the power supply unit.

The controller may estimate the temperature of the drum based on the measured impedance. The measured impedance may he defined as a value obtained by dividing a voltage value detected by the voltage detection unit by a current value detected by the current detection unit.

The controller may compensate an error based on the measured impedance and the equivalent impedance of the first and second circuits. The equivalent impedance of the first and second circuits may be an equivalent impedance at a resonant frequency.

The power supply may change an apply frequency, when the resonance frequency of the measured impedance is different from the resonance frequency of the equivalent impedance.

When the phase angle of the measured impedance is different from the phase angle of the equivalent impedance, the controller may compensate the error of phase angle by using the rotation angle of the drum.

According to an aspect of the present disclosure, the temperature of the load (drum) of the rotating induction heater may be estimated by using the NTC.

That is, a sensing coil (first coil) and a capacitor are configured in parallel to form a primary side (first circuit), and a secondary side (second circuit) configured. by an NTC and a second coil, and then the temperature of the drum can be estimated by using the voltage/current value of the NTC detected by the first coil.

At this time, the primary side (first circuit) may be attached in the opposite direction to the heater coil to minimize the magnetic effect with the induction heater coil, and the secondary side (second circuit) may be attached closely to the outer surface of one of three lifters located inside the load (drum).

To balance the high-speed rotating load (drum), a non-magnetic material that can balance the weight of the load (drum) can be attached inside or outside the remaining two lifters.

Therefore, the phase, frequency, and magnitude of the equivalent impedance Zeq may be derived by using the voltage and current values sensed from the primary side, and the Rntc value of the NTC and the temperature of the load (drum) may be estimated by using the derived value.

As a specific example for this, an embodiment of the present disclosure provides a laundry treating apparatus including a cabinet; a drum which is rotatably provided in the cabinet and accommodates a treating target (e.g. clothes); an induction heater which is spaced apart from the drum and disposed inside or on an inner wall of the cabinet to heat the drum; a first circuit which is disposed at a position spaced apart from the induction heater inside the cabinet or on an inner wall and includes a first coil; and a second circuit including a second coil which is disposed in the drum and disposed at a point in the drum area overlapping the first coil in a rotational direction of the drum when the drum rotates and a thermal variable resistance unit whose resistance changes according to the temperature of the drum.

A laundry treating apparatus according to another embodiment of the present disclosure includes: a tub; a drum which is rotatably provided in the tub and accommodates an object; an induction heater which is fixed to the tub while being spaced apart from the drum, and heats the drum; a first circuit which is installed in the tub and includes a first coil; and a second circuit having a second. coil which is installed in the drum and positioned to pass a point within an area of the drum overlapping with the first coil to interact within the circumferential direction range of the drum upon rotation of the drum and a thermal variable resistance unit that transmits to the second coil at least one value of voltage and current values according to the temperature of the drum.

Another embodiment of the present disclosure may include a controller which is connected to the first circuit, and estimates the temperature of the drum by using the at least one value of voltage and current values according to the temperature of the drum received due to the interaction between the second. coil and the first coil.

In addition, the first circuit may further include a capacitor connected in parallel with the first coil.

In addition, the laundry treating apparatus may include: a power supply unit; a current detection unit connected in series with the first coil; and a voltage detection unit connected in parallel with the first coil.

In addition, the power supply unit may apply a resonant frequency.

In addition, the capacitor may be for increasing the resolution of the value related to the temperature of the drum received. through the second coil.

In addition, the detection unit may be an NTC that outputs a resistance value that changes according to a temperature as a voltage value.

In addition, the size of the first coil may be larger than the size of the second coil.

In addition, the first coil may be installed in the opposite side of the induction heater in the tub.

In addition, the first coil may be installed in a range of ±60 degrees from the opposite side of the induction heater in the tub.

In addition, the second coil may be installed at a position passing the shortest distance from the first coil according to the rotation of the drum.

In addition, the second circuit may be installed on the outer surface of the drum.

In addition, the laundry treating apparatus may further include a balance maintaining unit installed at a position equalizing an angle with respect to a position where the second circuit of the drum is attached.

In addition, the controller may estimate the resistance value of the NTC and the temperature of the drum by comparing an impedance obtained by detecting the voltage and current values received from the second coil due to the interaction of the first coil and an equivalent impedance of the first and second circuits.

According to another embodiment of the present disclosure, a method of controlling a laundry treating apparatus including: a tub; a drum which is rotatably provided in the tub and accommodates an object; an induction heater which is fixed to the tub while being spaced apart from the drum, and heats the drum; a first circuit which is installed in the tub and includes a first coil; and a second circuit having a second coil which is installed in the drum and positioned to pass a point within an area of the drum overlapping with the first coil to interact within the circumferential direction range of the drum upon rotation of the drum and a detection unit that transmits to the second coil at least one value of voltage and current values according to the temperature of the drum, the method including: driving the laundry treating apparatus; detecting an output value of the detection unit through the first circuit; calculating an equivalent impedance of the first circuit; matching the impedance measured by an output value of the detection unit with a resonance frequency of the equivalent impedance; matching the impedance measured by the output value of the detection unit and the phase angle of the equivalent impedance; and estimating the temperature of the drum through the detection unit based on the magnitude of the equivalent impedance.

The matching of the resonance frequency may include: obtaining an error by comparing an impedance measured by an output value of the detection unit with a resonance frequency of the equivalent impedance; and compensating an error in the inductance value of the first coil.

The matching of the phase angles may include: obtaining an error by comparing the impedance measured by the output value of the detection unit with the phase angle of the equivalent impedance; and compensating the error in the phase angle by using the rotation angle of the drum

The driving of the laundry treating apparatus may include heating and rotating the drum; and applying a voltage of a resonant frequency to the first circuit.

In addition, the driving of the laundry treating apparatus may include the first coil and arranging the first coil.

According to another embodiment of the present disclosure, a laundry treating apparatus includes a fixing part such as a cabinet and a rotating part rotating with respect to the fixing part, wherein a first circuit including a first coil is disposed in the fixing part, and the rotating part includes a second circuit including a second coil disposed at a position corresponding to the first coil and a thermal variable resistance unit which is electrically connected to the second coil and has a flowing current value or voltage value which is changed as the internal resistance is changed according to the temperature of the rotating part, wherein the temperature of the rotating part is determined by the current value or voltage value of the first coil corresponding to the current value or voltage value of the second coil.

The fixing part may be an inner wall of the cabinet or any position inside the cabinet, and may be a tub which is disposed inside the cabinet to accommodate the rotating part.

In a dryer or laundry treating apparatus having no tub, the first circuit may be disposed on an inner wall of the cabinet at a lower portion or a side surface of the rotating part.

The rotating part includes a drum disposed to rotate inside the cabinet or the tub. The second circuit may be disposed in the drum, and may be disposed on an outer surface or an inner surface of the drum.

The laundry treating apparatus may include a lifter disposed inside the drum, and the second circuit may be disposed in a drum area corresponding to the lifter. The second circuit may be disposed on an outer surface of the drum corresponding co the lifter or an inner surface of the drum in which the lifter is mounted.

The first coil and the second coil are disposed to overlap each other with respect to the drum rotation direction The thermal variable resistance unit of the second circuit may be disposed in a drum area corresponding to the lifter or a drum area corresponding to the induction heater.

The first coil may be configured to be larger than or equal to the second coil. For example, the first coil may be configured to be larger than the second coil. Even if the first coil and the second coil have the same size, the number of turns of the first coil may be larger than the number of turns of the second coil.

A distance between the first coil and the second coil may be 28 mm to 30 mm.

The drum temperature may be estimated through the magnitude of the impedance at a specified frequency, when a frequency is specified between the first coil and the second coil.

The first coil may be disposed at a position opposite to the induction heater based on the drain rotation shaft, and may be disposed at a position within 90 degrees in both directions from a position opposite by 180 degrees to the induction heater.

The rotating part may dispose a balance weight at a position spaced apart from the second coil, and a laundry treating apparatus having a rotating part rotating at a low speed, such as a dryer, may not include the balance weight.

### Advantageous Effects

According to at least one of embodiments of the present disclosure, the temperature of a drum may be estimated by using the characteristics of a thermistor whose resistance changes according to a temperature.

According to at least one of embodiments of the present disclosure, the temperature may be estimated irrespective of a distance that is structurally generated due to a drum and a tub.

According to at least one of embodiments of the present disclosure, the temperature may be estimated even under a condition in which a load (drum) rotates.

In addition, the influence of an inductance/capacitance distribution on the temperature estimation can be reduced by including an NTC thermistor.

In addition, continuous temperature estimation can be performed without turning off a power device to estimate a temperature. Accordingly, the performance of laundry treating apparatus can be improved.

### DESCRIPTION OF DRAWINGS

FIG. 1 is a resonant circuit for using a method of estimating a temperature by using an inductance change.

FIG. 2 illustrates voltage waveform when a resonance frequency is measured in a resonance circuit of FIG. 1.

FIG. 3 is an enlarged view of a portion A of FIG. 2.

FIG. 4 is a graph illustrating a relationship between a temperature and a resonance frequency when estimating a temperature by using a resonance frequency.

FIG. 5 is a perspective view of a laundry treating apparatus according to an embodiment of the present disclosure.

FIG. 6 is a cross-sectional view or a laundry treating apparatus according to an embodiment of the present disclosure.

FIG. 7 is a conceptual diagram in which a separate type induction heater module is mounted in a tub.

FIG. 8 is a circuit diagram illustrating a circuit configuration of a laundry treating apparatus according to an embodiment of the present disclosure.

FIG. 9 is schematic diagram illustrating an installation position of a circuit configuration of a laundry treating apparatus according to an embodiment of the present disclosure.

FIG. 10 is a schematic diagram illustrating an example of installation of a first coil and a second coil of a laundry treating apparatus according to an embodiment of the present disclosure.

FIG. 11 is a graph illustrating a relationship between an impedance phase angle and a frequency of a laundry treating apparatus according to an embodiment of the present disclosure.

FIG. 12 is a graph illustrating a relationship between an impedance magnitude and a frequency of a laundry treating apparatus according to an embodiment of the present disclosure.

FIG. 13 is a graph illustrating a relationship between an impedance phase angle and a frequency under a simulation condition.

FIG. 14 is a graph illustrating a relationship between an impedance magnitude and a frequency under a simulation condition.

FIG. 15 is a graph illustrating a change in a resistance value according to a temperature of NTC.

FIG. 16 is a flowchart illustrating a method of controlling a laundry treating apparatus according to an embodiment of the present disclosure.

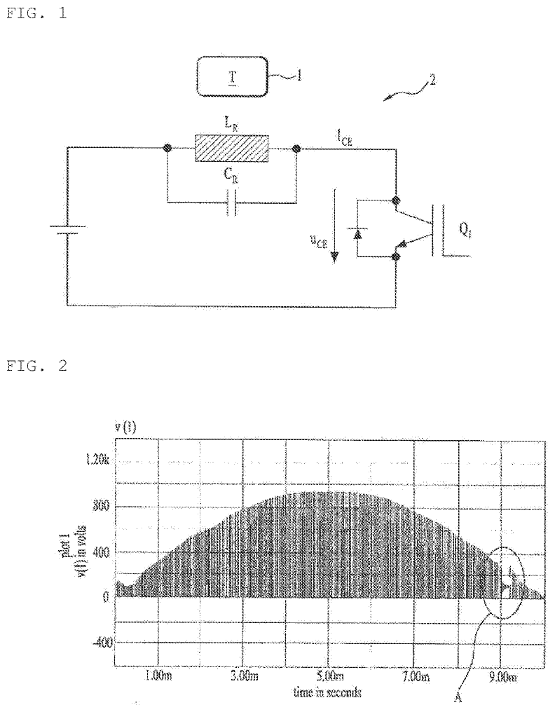

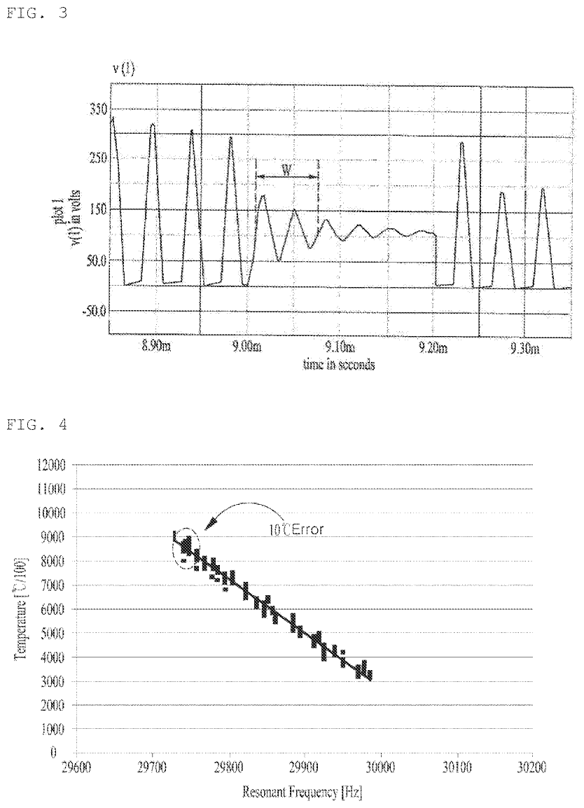

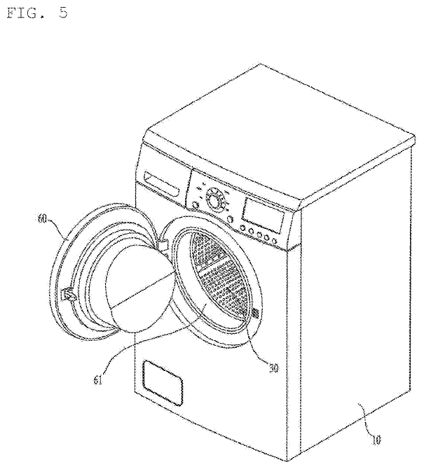

### MODE FOR INVENTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In general, suffixes such as “module” and “unit” may be used to refer to elements or components. Use of such suffixes herein is merely intended to facilitate description of the specification, and the suffixes do not have any special meaning or function.

In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another.

It will be understood that when an element is referred to as being “connected with” another element, there may be intervening elements present. In contrast, it will be understood that when an element is referred to as being “directly connected with” another element, there are no intervening elements present.

In addition, when an element such as a layer, an area, or a module is referred to as existing “on” another element, it can be appreciated that it directly exists on other element or an intervening element may exist therebetween.

A singular representation may include a plural representation unless context clearly indicates otherwise.

Furthermore, although each drawing is described for convenience of description, it is also within the scope of the present invention that those skilled in the art implement other embodiments by combining at least two or more drawings.

A laundry treating apparatus or the present disclosure may correspond to a washing machine, a dryer, and a washing machine integrated with a dryer (a dryer-integrated washing machine). Hereinafter, as a laundry treating apparatus of the present disclosure, a washing machine will be described as a representative example. However, the laundry treating apparatus of the present disclosure is not limited thereto.

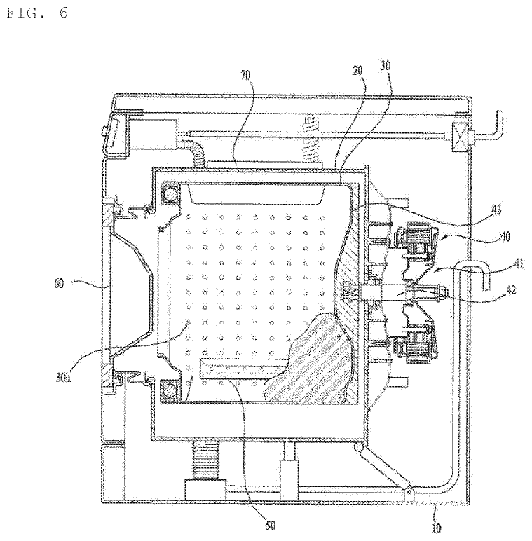

Hereinafter, a laundry treating apparatus according to an embodiment of the present disclosure will be described with reference to FIGS. 5 to 7.

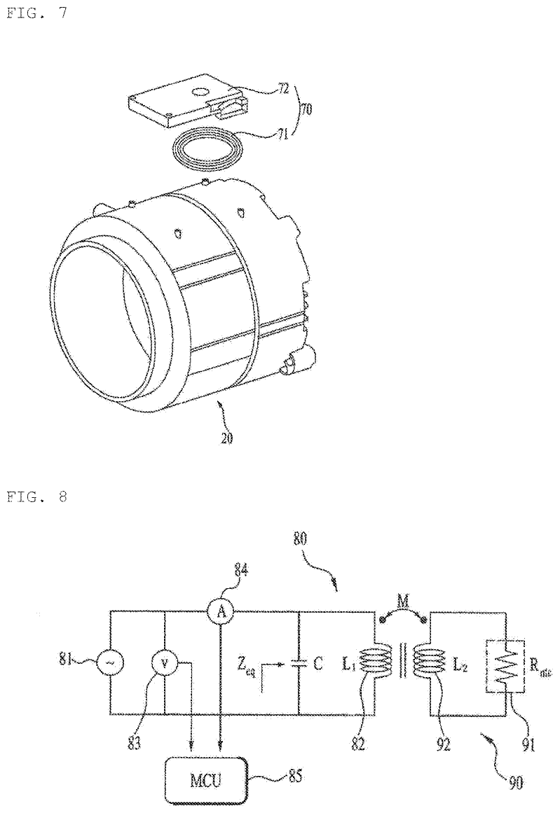

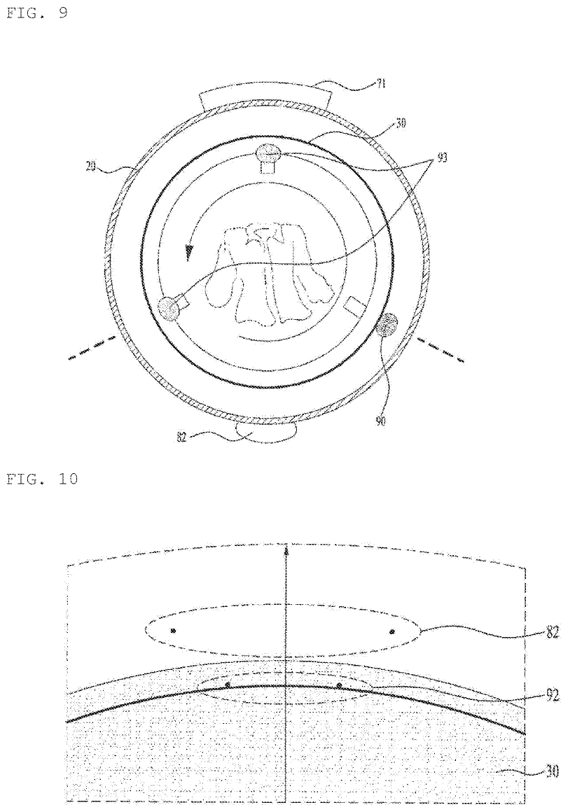

FIG. 5 is a perspective view illustrating an exterior of a washing machine according to an embodiment of the present disclosure. FIG. 6 is a cross-sectional view illustrating an interior of a washing machine according to an embodiment of the present disclosure. FIG. 7 is a conceptual diagram in which a separate type induction heater module is mounted on a tub.

A washing machine according to an embodiment of the present disclosure may include a tub 20 and a drum 30. The washing machine may further include a cabinet 10 forming an outer shape. The washing machine may further include an induction heater 70 provided to heat the drum 30.

The tub 20 may be provided inside the cabinet 10. The tub 20 may provide an accommodation space. The tub 20 may have an opening in a forward direction The tub 20 may accommodate washing water. The tub 20 may be provided to accommodate the drum 30.

The drum 30 may be rotatably provided inside the tub 20. The drum 30 may be provided in the accommodation space of the tub 20. The drum 30 may accommodate laundry. An opening may be provided in a forward direction of the drum 30. Laundry may be loaded into the drum 30 through the opening.

A through hole 30h may be formed n the circumferential surface of the drum 30 so that air and washing water are communicated between the tub 20 and the drum 30. Hereinafter, the circumferential surface of the drum 30 may also be referred to as a body of the drum 30. The body of the drum 30 may extend in a cylindrical shape.

The drum 30 may be made of a conductor. The body of the drum 30 may be made of a conductor. The body of the drum 30 may be made of metal.

The induction heater or IH module 70 may heat the drum 30. The induction heater 70 may generate a magnetic field. The induction heater 70 may be provided to heat the drum 30 by using a magnetic field.

The induction heater 70 may be provided on the outer circumferential surface of the tub 20. The induction heater 70 may be provided in the upper portion of the tub 20. The induction heater 70 may be fired to the tub 20. The induction heater 70 may be spaced apart from the drum 30.

The tub 20 and the drum 30 may be formed in a cylindrical shape. The inner and outer circumferential surfaces of the tub 20 and the drum 30 may be formed in a substantially cylindrical shape.

Meanwhile, a laundry treating apparatus such as a dryer may not include a tub. The induction heater 70 may be provided in the cabinet. The induction heater 70 may be disposed inside the cabinet or on an inner wall. The induction heater 70 may be spaced apart from the drum 30 and fixed to the cabinet 10.

FIG. 6 shows a washing machine in which the drum 30 is rotated based on a rotation shaft parallel to a ground. Unlike the drawing, the drum 30 and the tub 20 may have a tilting shape inclined rearward direction. The rotation shaft of the drum 30 may penetrate the rear surface of the washing machine. That is, a straight line extending from the rotation shaft 42 of a driving unit 40 may penetrate the rear surface of the washing machine.

The washing machine may further include a driving unit 40 provided to rotate the drum 30 inside the tub 20. The driving unit 40 may include a motor 41. The motor 41 may include a rotation shaft 42. The rotation shaft 42 may be connected to the drum 30 to rotate the drum 30 inside the tub 20.

The motor 41 may include a stator and a rotor. The rotor may be connected to the rotation shaft 42.

The driving unit 40 may include a spider 43, The spider 43 is a configuration that connects the drum 30 and the rotation shaft 42, and may be a configuration for uniformly and stably transmitting the rotational force of the rotation shaft 42 to the drum 30.

The spider 43 may be coupled to the drum 30 in such a manner that at least portion of the spider 43 is inserted into the rear wail of the drum 30. To this end, the rear wall of the drum 30 may be formed in such a manner that it is recessed to the inside of the drum 30. In addition, the spider 43 may be coupled to the drum 30 in such a manner that it is further inserted into the drum 30 at a portion of the center of rotation of the drum 30.

A lifter 50 may he provided inside the drum 30. A plurality of lifters 50 may be provided along the circumferential direction of the drum 30. The lifter 50 may perform a function of agitating a laundry. For example, as the drum 30 rotates, the lifter 50 lifts a laundry to an upper portion.

The laundry moved to the upper portion is separated from the lifter 50 by gravity and falls to a lower portion Washing may be performed by an impact force caused by the falling of such laundry. Agitation of laundry can enhance drying efficiency.

The lifter 50 may be formed by extending from a rear end of the drum 30 to a front end. Laundry may be evenly distributed back and forth inside the drum 30.

The induction heater 70 is a device for heating the drum 30.

As shown FIG. 7, the induction heater 70 may include a coil 71 that receives a current to generate a magnetic field. The coil 71 may generate an eddy current in the drum 30.

The induction heater 70 may include a heater cover 72 accommodating the coil 71. Hereinafter, a structure of the induction heater 70 and the principle of heating the drum 30 by the induction heater 70 will be omitted.

In the washing machine, the coil 71 heats the drum 30 to increase the temperature inside the drum 30 as well as the drum 30 itself. The induction heater 70 may heat the wash water in contact with the drum 30 through the heating of the drum 30. The induction heater 70 may heat the laundry in contact with the inner circumferential surface of the drum 30. The induction heater 70 may heat the laundry that is not in contact with the inner circumferential surface of the drum 30 by increasing the temperature inside the drum 30.

The induction heater 70 may increase the washing effect by increasing the temperature of washing water, and laundry, and the ambient temperature inside the drum 30. The induction heater 70 may dry a laundry by increasing the laundry, the drum 30 and the ambient temperature inside the drum 30.

FIG. 7 shows that the induction heater 70 is provided in the upper side of the tub 20, but it is not excluded that the induction heater 70 is provided on at least one surface of the upper side, lower side, and both sides of the tub 20. The induction heater 70 may be installed at a position higher than the maximum water level of the was water stored in the tub 20.

The induction heater 70 may be provided in one side of the outer circumferential surface of the tub 20, and the coil 71 may be provided to be wound at least once inside the cover 72 along a surface of the induction heater 70 adjacent to the tub 20.

The induction heater 70 may generate an eddy current in the drum 30 by emitting an induced magnetic field directly to the outer circumferential surface of the drum 30, and as a result, may directly heat the outer circumferential surface of the drum 30.

The laundry treating apparatus according to an embodiment of the present disclosure may include a controller (not shown, it may have the same configuration as a controller 85 of FIG. 8; hereinafter, it will be described using reference numeral 85) for controlling an output of the induction heater 70. The controller 85 may control an on/off and an output of the induction heater 70.

The induction heater 70 may be connected to an external power supply source by an electric wire to receive power. Alternatively, the induction heater 70 may be connected to the controller 85 for controlling the operation of washing machine to receive power. The induction heater 70 may receive power from anywhere as long as it can supply power to the internal coil 71.

When power is supplied to the induction heater 70 and AC current flows through the coil 71 provided in the induction heater 70, the drum 30 is heated.

If power is supplied to the induction heater 70 and the drum 30 does not rotate, only a partial surface of the drum 30 is heated. Therefore, partial surface may be overheated and remaining surface of the drum 30 may not be heated or may be heated to a small degree. In addition, heat may not be smoothly supplied to the laundry accommodated in the drum 30.

The controller 85 may rotate the drum 30 through the motor 41 of the driving unit 40 when the induction heater 70 is operated. The controller 85 may cause the induction heater 70 to operate when the drum 30 rotates.

If all surfaces of the outer circumferential surface of the drum 30 can face the induction heater 70, the speed at which the motor 41 of the driving unit 40 rotates the drum 30 can safely be any speed.

Meanwhile, as the drum 30 rotates, all surfaces of the drum 30 may be heated, and the laundry inside the drum 30 may be evenly exposed to heat.

Accordingly, the laundry treating apparatus according to an embodiment of the present disclosure can evenly heat the outer circumferential surface of the drum 30, even if the induction heater 70 is not installed in places such as the upper side, the lower side, both sides of the outer circumferential surface of the tub 20, but is installed only in one place.

According to an embodiment of the present disclosure, the induction heater 70 can heat the drum 30 to a high temperature within a very short time. The induction heater 70 can heat the drum 30 to a target temperature within a very short time. The induction heater 70 can heat the drum 30 to 120 degrees Celsius or more within a very short time.

When the induction heater 70 is driven in a state where the drum 30 is stopped or is at a very slow rotation speed, a specific portion of the drum 30 may be overheated very quickly. When the induction heater 70 is driven in a state where the drum 30 is stopped or is at a very slow rotation speed, heat may not be sufficiently transmitted from the heated drum 30 to the laundry.

A correlation between the rotational speed of the drum 30 and the driving of the induction heater 70 may be very important. It may be more advantageous to rotate the drum 30 and drive the induction heater 70 than to drive the induction heater 70 and rotate the drum 30.

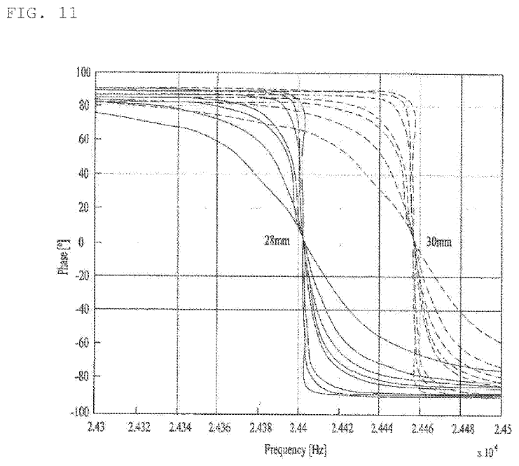

FIG. 8 is a circuit diagram illustrating a circuit configuration of a washing machine according to an embodiment of the, present. disclosure. In addition, FIG. 9 is a schematic diagram illustrating an installation position of a circuit configuration of a washing machine according to an embodiment of the present disclosure.

Hereinafter, a circuit configuration of a laundry treating apparatus according to an embodiment of the present disclosure will be described in detail with reference to FIGS. 8 and 9.

The laundry treating apparatus according to an embodiment of the present disclosure may include a first circuit 80 which is installed in the tub 20 and includes a first coil 82, a second coil 92 which is installed in the drum 30 and located to pass a point that interacts with the first coil 82 when the drum 30 rotates, and a second circuit 90 including a thermistor 91 whose resistance varies depending on temperature.

Like this, the second coil may be installed in the drum 30, and may be located to pass a point within an area of the drum 30 overlapping to interact within a circumferential range of the first coil 62 and the drum 30 when the drum 30 rotates.

In addition, the washing machine according to an embodiment of the present disclosure may include a controller MCU 85 which is connected to the first circuit 80 and estimates a temperature of the drum 30 by using a value related to the temperature of the drum 30 received by the interaction between the second coil 92 and the first coil 82.

Meanwhile, a laundry treating apparatus such as a dryer may not include a tub. The first circuit 80 may be disposed at a position capable of interacting with the second coil according to the rotational position of the drum on the inside or the inner wall of the cabinet 10.

As shown in FIG. 8, the first circuit 80 may further include a capacitor connected in parallel with the first coil 82.

The laundry treating apparatus may include a current detection unit 84 connected in series with the first coil 62 and a voltage detection unit 83 connected in parallel with the first coil 82.

The thermistor 91 may be a Negative Temperature Coefficient-thermic resistor (NTC-thermistor) whose resistance decreases as the temperature increases. Hereinafter, the NTC-thermistor is also briefly referred to as an NTC.

The resistance value of the NTC may be referred to as Rntc. The NTC may have a resistance value Rntc that exponentially decreases according to the temperature of a load (drum). Hereinafter, the thermistor 91 and the NTC 91 will be described by using the same reference numeral.

As described above, the second circuit 90 installed in the drum 30 may output at least one (hereinafter, it will be expressed as a voltage value and/or a current value) of a voltage value and a current value according to a resistance value that decreases according to the temperature of the NTC 91.

The output voltage value and/or current value of the NTC 91 may be transmitted to the second coil 92. Thereafter, this value may be transmitted to the first circuit 80 by the interaction between the first coil 82 and the second coil 92. That is, a current that fluctuates according to a change in the resistance value of the NTC 91 can be transmitted to the first coil 82 of the first circuit 80 by the interaction between the first coil 82 and the second coil 92. In this case, the interaction may be an electromagnetic induction phenomenon in which current/voltage is induced between the first coil 82 and the second coil 92.

The controller 85 may estimate a resistance value of the NTC 91 by using impedance obtained by detecting the voltage and current values obtained at this time. The controller 85 may estimate the temperature of the drum 30 from the estimated resistance value of the NTC 91.

The controller 85 may compensate an error in the resistance value of the NTC 91 by comparing the impedance obtained by detecting the voltage and current values with an equivalent impedance of the first and second circuits 90 viewed. from the capacitor. Through this, the error the estimated temperature of the drum 30 can be compensated.

The process of estimating the temperature of the drum 30 will be described later in detail.

A power supply unit 81 of the first circuit 80 may apply a resonant frequency. This resonant frequency may be the same as the frequency of a signal induced to the primary coil 82 through the secondary coil 92.

Impedance can be defined as a ratio of AC voltage and current which are generated in a reference point or applied to a specific object. An alternating signal, such as an AC voltage, has a phase. In order to compare the phases, it is necessary that the frequencies of two signals have the same state. This is because comparing of the phases may not be meaningful if the frequencies are different.

Therefore, in order to compare the measured impedance and the equivalent impedance, it may be necessary to compare the (resonant) frequency and then compare the phase angle.

Meanwhile, the capacitor C may increase the resolution (degree of change; degree of discrimination) of a value related to the temperature of the drum 30 received through the second coil 92.

For example, in the case of a washing machine combined with dryer, a distance between the first coil 82 and the second coil 92 may occur due to a structural distance between the drum 30 and the tub 20. The distance between the first coil 82 and the second coil 92 may be, for example, 28 mm to 30 mm. Accordingly, a mutual inductance M between the first coil 82 and the second coil 92 may be reduced.

Due to this, a change in the resistance value of the NTC 91 may not be significantly observed in the first circuit 80. The capacitor C may compensate a phenomenon in which a change in the resistance value of the NTC 91 may not be significantly observed in the first circuit 80.

Referring to FIG. 9, the first coil 82 may be installed on the tub 20, in the opposite side of the coil 71 of the induction heater 70. In addition, the first coil 82 may be installed on the tub 20, in a range of ±60 degrees from the opposite side of the coil 71 of the induction heater 70.

That is, in the case of a washing machine combined with dryer, the first coil 82 may be installed in the tub 20. The first coil 82 may be located on the tub 20 in a direction opposite to the coil 71 of the induction heater 70. Accordingly, the influence of the magnetic field generated in the coil 71 of the induction heater 70 on the first coil 82 may be minimized.

Meanwhile, the first coil 82 may be installed within a range between positions of adjacent lifters indicated by dotted line in FIG. 9. That is, the first coil 82 may be installed. on the tub 20 in a range within ±60 degrees from the opposite side of the coil 71 of the induction heater 70. Accordingly, the influence of the magnetic field generated in the coil 71 of the induction heater 70 on the first coil 82 may be minimized. Thus, interference of the first coil 82 with other structure that may be provided under the tub 20 such as a washing heater other than the induction heater 70 can be avoided.

The second coil 92 may be installed at a position passing the shortest distance from the first coil 82 according to the rotation of the drum 30. That is, when the drum 30 rotates, the second coil 92 installed in the drum 30 may pass a position of the shortest distance from the first coil 82.

In addition, the second circuit 90 including the second coil 92 may be stalled on the outer surface of the drum 30.

In the case of a washing machine combined with dryer, the second circuit 90 including the NTC 91 and the second coil 92 in the outside of the drum 30 can be installed at the lifter position of the drum 30 that is a load. Here, the dotted line in FIG. 9 indicates the position of the lifter.

When the second it 92 is installed inside the drum 30, current may not be transmitted to the first coil 82 side due to the material characteristics of the load (drum 30).

Meanwhile, a balance maintaining unit 93 may be provided at a position that divides the circular angle of the drum 30 into equal parts with respect to a position where the second circuit 92 of the drum 30 is attached.

For example, the case of a washing machine combined with dryer, it may be necessary to maintain the weight balance when rotating at high speed. Therefore, a weight balance may be achieved by attaching the balance maintaining unit 93 made of a material having non-magnetic properties.

In this case, for example, when the lifter is located at a position where the angle of the drum 30 is divided into three equal parts, and the second circuit 90 is provided in any one of three parts, such a balance maintaining unit 93 may be installed in the other two parts.

For example, in case of a dryer, it may not rotate at a high speed, the balance maintaining unit 93 for maintaining a weight balance may not be installed.

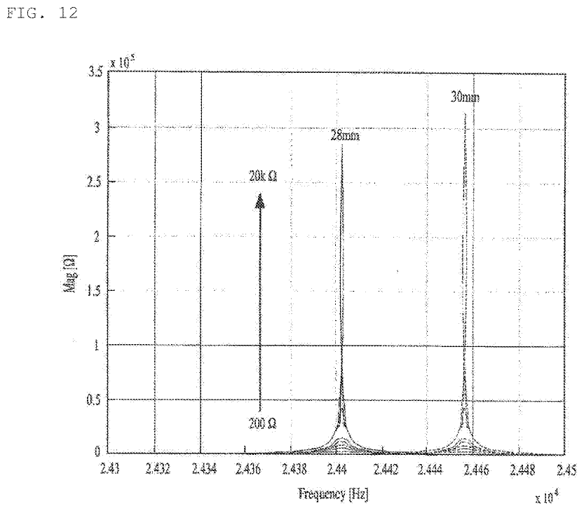

FIG. 10 is a schematic diagram illustrating an example of installation of a first coil and a second coil of a laundry treating apparatus according to an embodiment of the present disclosure.

Referring to FIG. 10, the size of the first coil 82 may be greater than the size of the second coil 92. That is, it may be advantageous that the size of the first coil 82 acting as a sensing coil is designed to be larger than the size of the second coil 92 transmitting a signal so as to maintain a constant inductance (L1, L2, M) value even during the rotation of the drum 30 in consideration of the rotation of the load (drum 30).

In addition, depending on a distance between the applied washing machine and the first coil 82 and the second coil 92, it may be necessary to optimize the number of turns of the first coil 82 and the value of the parallel capacitor C.

Meanwhile, the temperature error can be minimized by compensating an error by using rotation angle information of the drum 30.

Hereinafter, a process of estimating the temperature of the drum 30 by using a circuit configuration of the washing machine according to an embodiment of the present disclosure shown in FIG. 8 will be described in detail.

Equation 1 is a calculation expression representing the equivalent impedance Zeq viewed from the first circuit 80 (first side). More specifically, Equation 1 is a calculation expression representing the equivalent impedance Zeq of the first and second circuits 80 and 90 viewed from the capacitor C. The explanation in terms of the equivalent impedance Zeq of the first and second circuits 80 and 90 shown in FIG. 8 is as follows,

$$\text{?} \qquad [ Equation 1 ]$$

$$\text{?} \text{indicates text missing or illegible when filed}$$

In Equation 1, L1 is an inductance of the first coil 82, L2 is an inductance of the second coil 92, and M is a mutual inductance. ω represents a (resonant) frequency, and C represents a capacitance of the capacitor of the first circuit 80.

Referring to Equation 1, the equivalent impedance Zeq of the first and second circuits 80 and 90 at a resonant frequency is briefly summarized as follows.

$$\text{?} \qquad [ Equation 2 ]$$

$$\text{?} \text{indicates text missing or illegible when filed}$$

Referring to Equation 1 or Equation 2 above, it can be seen that the equivalent impedance Zeq of the first and second circuits 90 viewed from the capacitor C varies greatly according to a change in Rntc which is a resistance value of the NTC 91. That is, the equivalent impedance Zeq is proportional to the resistance Rntc of the NTC 91.

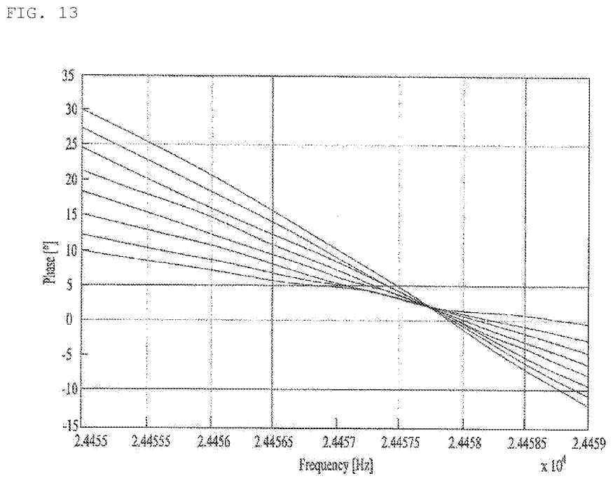

FIG. 11 is a graph illustrating a relationship between an impedance phase angle and a frequency. In addition, FIG. 12 is a graph illustrating a relationship between an impedance magnitude and a frequency.

Referring to FIGS. 11 and 12, it can be seen that the temperature estimation of the temperature estimation circuit using the NTC 91 is sufficiently possible.

As can be seen in FIGS. 11 and 12, it can be seen that both the phase angle and the magnitude of the equivalent impedance Zeq viewed from the first side (the first circuit 80) change significantly.

At this time, as in FIG. 11, if a distance between the first side (first circuit 80) and the second side (second circuit 90) is changed, the impedance phase angle is changed to specify a frequency to be measured. Thus, in order to compare two impedances, it may be necessary to specify a frequency.

In addition, as shown in FIG. 12, the temperature may be estimated by measuring the magnitude of the impedance at the frequency specified above.

At this time, it can be seen that the magnitude of the impedance changes 100 times from 200 Ω to 20 kΩ, which may mean that the discrimination power for temperature estimation is sufficient.

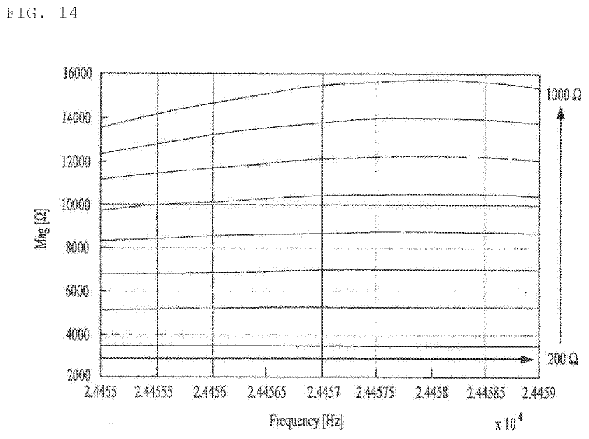

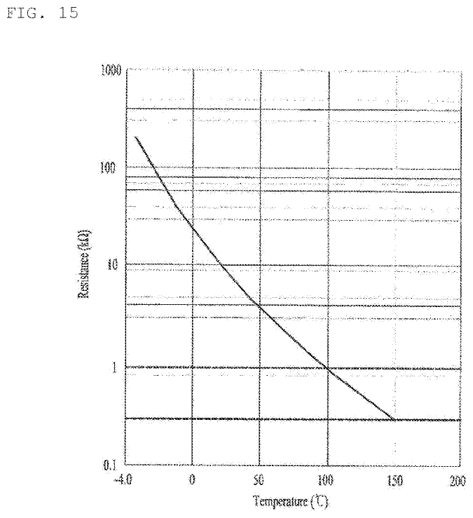

Hereinafter, a temperature estimation process under a specific simulation condition will be described with reference to FIGS. 13 and 14.

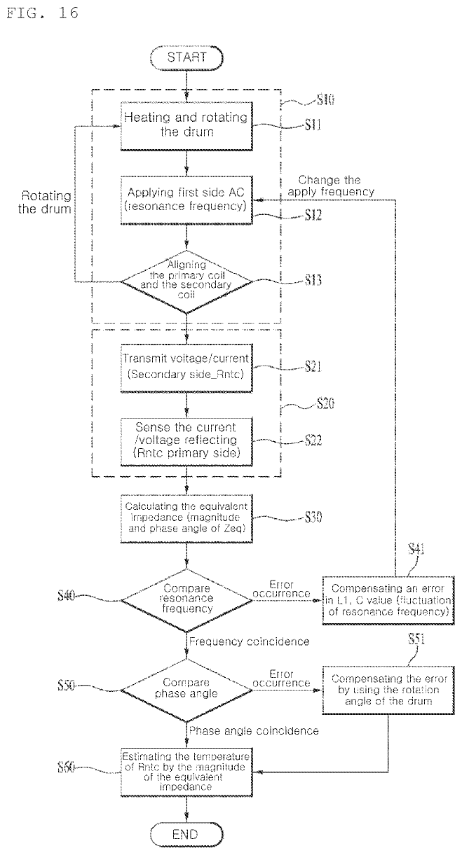

FIG. 13 is a graph illustrating a relationship between an impedance phase angle and a frequency under a simulation condition In addition, FIG. 14 is a graph illustrating a relationship between an impedance magnitude and a frequency under a simulation condition FIG. 15 is a graph illustrating a change in a resistance value according to a temperature of NTC.

At this time, the first side coil turn ratio of the first coil 82 and the second coil 92 is 5 to 5 (5:5), and a distance between the first circuit 80 and the second circuit 90 is 30 mm.

When a specific inductance L1, L2, M value for simulation is applied, and a distance between the first side (first circuit 80) and the second side (second circuit 90) is 30 mm, Equation 2 is summarized as follows,

$${\frac{{L}_{1}^{2}}{{M}^{2}} \vert}_{d = 30 mm} = 17.4875 \qquad [ Equation 3 ]$$

$${\sqrt{\frac{{L}_{1}}{C}} [ 1 - \frac{{L}_{1} {L}_{2}}{{M}^{2}} ] \vert}_{d = 30 mm} = - 167 \qquad [ Equation 4 ]$$

As shown in FIG. 13 and FIG. 14, the Rntc value of the NTC 91 may be derived by using the phase of the equivalent impedance Zeq and the impedance magnitude at a specific frequency.

At this time, as shown in FIG. 15, it can be seen that the Rntc value of the NTC 91 varies from 200 to 1000 Ω, and at this time, the temperature of the NTC varies from 100 to 150° C.

As described above, according to the present disclosure, the temperature of the drum 30 can be estimated with a sufficient. accuracy by using a circuit shown in FIG. 8.

According to an embodiment of the present disclosure as described above, accurate temperature estimation may be possible by using the characteristic of the NTC resistance that exponentially decreases depending on temperature.

In addition, it may be possible to estimate the temperature regardless of a distance that is structurally generated due to the drum and the tub.

In addition, accurate temperature estimation may be possible even under a rotating load (drum) condition

In addition, since the temperature is estimated by using the NTC resistance, the influence on the inductance/capacitance distribution may be small.

For temperature estimation, since continuous temperature estimation is possible without turning off a power device, high efficiency can be achieved in case of being applied to a product.

FIG. 16 is a flowchart illustrating a method of controlling a laundry treating apparatus according to an embodiment of the present disclosure.

According to an embodiment of the present disclosure, the temperature of the drum 30 of the washing machine may be estimated by using the circuit as described with reference to FIG. 8.

That is, due to an interaction between the first coil 82 included in the first circuit 80 and the second coil 92 included in the second circuit 90, the resistance value of the NTC 91 and the temperature of the drum 30 can be estimated by comparing the impedance obtained by detecting the voltage and current values received from the second coil 92 with the equivalent impedance of the first and second circuits 80 and 90 viewed from the first circuit 80.

Hereinafter, a process of estimating the temperature of the drum 30 of the laundry treating apparatus by using the first circuit 80 and the second circuit 90 will be described in detail with reference to FIGS. 8 and 16 together.

First, a step S10 of driving the laundry treating apparatus may be performed. In this case, as mentioned above, the laundry treating apparatus may correspond to a washing machine, a dryer, and a washing machine (dryer-integrated washing machine) which is integrated with a dryer. Hereinafter, as a laundry treating apparatus of the present disclosure, a washing machine will be described as a representative example. However, the laundry treating apparatus of the present disclosure is not limited thereto.

The step S10 of driving the laundry treating apparatus may include a process S11 of heating and rotating the load (drum 30).

In addition, the step S10 of driving the laundry treating apparatus may include a process S12 of applying a resonance frequency to the power supply unit 81 of the first circuit (first side 80).

In addition, the step S10 of driving the laundry treating apparatus may include the process of aligning the first coil 82 (primary coil) and the second coil 92 (secondary coil). The process of aligning the first coil 182 (primary coil) and the second coil 92 (secondary coil) may be performed automatically or manually in the washing machine. In addition, in some cases, the process of aligning the first coil 82 (primary coil) and the second coil 92 (secondary coil) may be omitted.

When the process of aligning the first coil 82 (primary coil) and the second coil 92 (secondary coil) is performed, a process S11 of heating and rotating the load (drum 30) may be performed after such an alignment process.

Thereafter, a step S20 of detecting the output value of the second circuit 90 through the first circuit 80 may be performed. In this case, the second circuit 90 may include the thermistor 91. The thermistor 91 may be an NTC thermistor 91.

The resistance of the NTC 91 may be changed by heating the drum 30. Such a change in resistance may follow the graph shown in FIG. 15. The change in a curve in this graph may vary according to the NTC 91.

When the resistance of the NTC 91 changes and the drum 30 rotates, the output current (and/or voltage) of the NTC 91 may be transmitted to the first coil 82 through the second coil 92 (S21). That is, the output current (and/or voltage) by Rntc, which is the resistance value of the NTC 91 in the second side, may be transmitted to the first coil 82.

Accordingly, in the first circuit 80, the current (and/or voltage) reflecting Rntc may be detected (S22).

Then, a step S30 of calculating the equivalent impedance of the first and second circuits 80 may be performed. by using the current (and/or voltage) value reflecting the detected Rntc.

The step S30 of calculating the equivalent impedance may include a process of determining the magnitude and phase angle of the equivalent impedance Zeq.

As mentioned above, impedance can be defined. as the ratio of AC voltage and current which are generated in a reference point or applied to a specific object. An alternating signal, such as an AC voltage, has a phase. In order to compare the phases, it may be necessary for the frequencies of two signals have the same state. This is because comparing the phases may not be meaningful if the frequencies are different.

Therefore, in order to compare the measured impedance and the equivalent impedance, it may be necessary to compare the (resonant) frequency and then compare the phase angle.

First, steps (S40, S41) of matching the impedance measured by an output value of the second circuit 90 with the resonance frequency of the equivalent impedance Zeq may be performed.

At this time, the steps (S40, S41) of matching the resonance frequency may include a step S40 of comparing the impedance measured by an output value of the second circuit 90 with the resonance frequency of the equivalent impedance Zeq to obtain an error, and a step S41 of compensating an error in the inductance value of the first coil 82.

That is, if an error occurs by comparing the impedance measured by the output value of the second circuit 90 with the resonance frequency, of the equivalent impedance Zeq, the error in the inductance value L1 of the first coil 82 can be compensated. In this case, the error value may include a capacitance value C.

Thus, an applied frequency applied to the power supply unit 81 of the first side 80 may be changed according to the compensated error value.

Next, steps (S50, S51) of matching the impedance measured by the output value of the second circuit 90 with the phase angle of the equivalent impedance Zeq may be performed.

That is, steps (S50, S51) of matching the phase angle may include a step S50 of comparing the impedance measured by the output value of the second circuit 90 and the phase angle of the equivalent impedance Zeq to obtain an error, and a step S51 of compensating the error of phase angle by using the rotation angle of the drum 30.

That is, if an error occurs by comparing the impedance measured by the output value of the second circuit 90 and the phase angle of the equivalent impedance Zeq, compensation for the error using the rotation angle or the load (drum 30) can be performed.

Through this process, when the frequency and phase angle of the impedance and the equivalent impedance Zeq coincide, a step S60 of estimating the temperature of the drum 30 through the thermistor NTC 91 with the magnitude of the equivalent impedance Zeq can be performed.

At this time, the compensation of the error using the rotation angle of the load (drum 3) may be applied to the step S60 of estimating the temperature of the drum 30 through the thermistor (NTC) 91 with the magnitude of the equivalent impedance Zeq.

Certain embodiments or other embodiments of the disclosure described above are not mutually exclusive or distinct from each other. Any or all elements of the embodiments of the disclosure described above may be combined with another or combined with each other in configuration or function

For example, a configuration “A” described in one embodiment of the disclosure and the drawings and a configuration “B” described in another embodiment of the disclosure and the drawings may be combined with each other. Namely, although the combination between the configurations not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fail within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled is the art.

1-15. (canceled)

16. A laundry treating apparatus comprising:
a tub;
a drum rotatably disposed in the tub;
an induction heater that is fixed to the tub and spaced apart from the drum, the induction heater being configured to heat the drum;
a first circuit comprising a first coil disposed at the tub;
a power supply configured to supply an alternating current (AC) power to the first coil; and
a second circuit disposed at the drum, the second circuit comprising:
a second coil configured to be disposed at a position overlapping with the first coil based on rotation of the drum, and
a thermistor having a resistance that varies based on a temperature of the drum

17. The laundry treating apparatus of claim 16, wherein the thermistor comprises a negative temperature coefficient (NTC) thermistor having the resistance that decreases based on an increase of the temperature of the drum

18. The laundry treating apparatus of claim 16, wherein the second coil is configured to be disposed on a straight line that passes through the first coil and that is perpendicular to a rotation shaft of the drum

19. The laundry treating apparatus of claim 16, wherein the second circuit is disposed at an outer surface of the drum

20. The laundry treating apparatus of claim 19, further comprising a lifter disposed at an inner surface of the drum, wherein the second circuit is disposed at a portion of the outer surface of the drum facing the lifter.

21. The laundry treating apparatus of claim 20, wherein the drum comprises a body that has an elongated cylindrical shape and that defines a through hole.

22. The laundry treating apparatus of claim 20, further comprising a plurality of lifters that are disposed at an inner surface of the drum and arranged at regular intervals along a circumferential direction of the drum,
wherein the second circuit is disposed at a portion of the outer surface of the drum facing any one lifter among the plurality of lifters, and
wherein the laundry treating apparatus further comprises a non-magnetic balance maintaining unit that is disposed inside the drum and faces another lifter among the plurality of lifters.

23. The laundry treating apparatus of claim 16, further comprising one or more non-magnetic balance maintaining units that are disposed adjacent to the drum,
wherein the second circuit and the one or more balance maintaining units are arranged at regular intervals along a circumferential direction of the drum

24. The laundry treating apparatus of claim 16, wherein the first coil is disposed at an opposite side of the induction heater with respect to a center of the tub.

25. The laundry treating apparatus of claim 24, wherein the first coil is disposed within a range of ±60 degrees from a point opposite to the induction heater with respect to the center of the tub.

26. The laundry treating apparatus of claim 16, wherein a first area covered by the first coil in a circumferential direction of the drum is greater than a second area covered by the second coil in the circumferential direction of the drum

27. The laundry treating apparatus of claim 16, wherein the first circuit further comprises a capacitor connected electrically in parallel to the first coil.

28. The laundry treating apparatus of claim 16, further comprising a controller that is connected to the first circuit and configured to estimate the temperature of the drum based on the resistance of the thermistor.

29. The laundry treating apparatus of claim 28, further comprising:
a current sensor connected electrically in series to the first coil; and
a voltage sensor connected electrically in parallel to the first coil.

30. The laundry treating apparatus of claim 29, wherein the controller is configured to estimate the temperature of the drum based on a measured impedance that is defined by dividing a voltage value detected by the voltage sensor by a current value detected by the current sensor.

31. The laundry treating apparatus of claim 29, wherein the thermistor is spaced apart from the first coil and connected electrically in series to the second coil.

32. The laundry treating apparatus of claim 31, wherein the power supply is spaced apart from the second coil and connected electrically in parallel to the first coil.

33. The laundry treating apparatus of claim 32, wherein the first circuit further comprises a capacitor connected electrically in parallel to the first coil.

34. The laundry treating apparatus of claim 16, wherein a width of the first coil is greater than or equal to a width of the second coil.

35. The laundry treating apparatus of claim 34, wherein a first number of turns of the first coil is greater than a second number of turns of the second coil.
